(19) United States
(12) Patent Application Publication
(10) Pub. No.: US 2026/0121563 A1
(43) Pub. Date: Apr. 30, 2026

(54) DEVICE AND METHOD FOR OPERATING AN ELECTRIC MOTOR AS WELL AS SYSTEM COMPRISING THE DEVICE AND THE ELECTRIC MOTOR

(71) Applicant: ebm-papst Mulfingen GmbH & Co. KGaA & Co. KG, Mulfingen (DE)

(72) Inventors: Dr. Sebastian Schroth, Kupferzell (DE); Marius Greiss, Würzburg (DE)

(21) Appl. No.: 19/368,380

(22) Filed: Oct. 24, 2025

(30) Foreign Application Priority Data
Oct. 24, 2024 (DE) 10 2024 130 971.7

(51) Int. Cl. H02P 21/22; H02P 25/03

(52) U.S. Cl. CPC H02P 21/22; H02P 21/141; H02P 25/03

(57) ABSTRACT

The present disclosure refers to a device as well as a method for operating an electric motor. The device has a preferably passive rectifier circuit and a controllable inverter circuit. A desired current form or a desired current progress for at least one phase of the supply current is preset. Based on a vector closed-loop control of the electric motor a first rotor current in a coordinate system fixed to the rotor can be determined, wherein the first rotor current does not influence the mechanical power of the electric motor. Based on the rotor current id then one or more control signals for controlling the inverter circuit can be determined in a control circuit and the inverter circuit can be controlled accordingly, wherein the desired current progress for the concerned current or the concerned currents result.

### CROSS REFERENCE TO RELATED APPLICATIONS

This application claims priority under 35 U.S.C. § 119 to the following German Patent Application No. 10 2024 130 971.7, filed on Oct. 24, 2024, the entire contents of which are incorporated herein by reference thereto.

### TECHNICAL FIELD

The present disclosure refers to a device for operating an electric motor, a system comprising the device and the electric motor and a method for operating the electric motor.

### BACKGROUND

During operation of electric motors it can be required or desired to influence the reactive power consumed from the supply grid in order to regulate and preferably minimize the load of the supply grid due to reactive power. For this purpose it is known to use methods for power factor correction (PFC).

EP 3 772 165 A1 describes a device for operating a rectifier that is connected to the supply grid. The rectifier comprises a rectifier circuit for creation of a rectified voltage that is supplied to the input side of a direct voltage controller. The direct voltage controller is controlled, so that the harmonic component in a supply current consumed from the supply grid is minimized.

EP 2 482 442 A1 discloses a method and a control system for controlling a brushless electric motor. Hereby a three-phase supply voltage of a supply grid is first rectified into a rectified voltage in a DC link and the latter is then transformed by means of an inverter for the operation of the electric motor. A smoothing capacitor in the DC link shall be omitted or shall have only a low impedance. The rectified voltage in the DC link is monitored with regard to its alternating component and depending on the amount of the alternating component a control of the motor is influenced in order to limit the alternating component. This is achieved by a respective clocking of the inverter. It is hereby disadvantageous that for the influence of the supply current consumed from the supply grid an additional device is required, such as a device for power factor correction.

From EP 2 276 162 A1 a method and a control system for controlling a brushless electric motor are known. A dynamic field attenuation with double grid frequency shall be achieved based on a vector control using a rotor current. The phase position and the amplitude of the rotor current are controlled so that the ripples of another rotor current, which determines the torque of the electric motor, is minimum. Thereby electrical energy recovery into the DC link and a link capacitor provided there occurs. If the link capacitor fully charges for reducing the torque ripples, the consumption of electrical energy from the supply grid is blocked. In this case an influence of the supply current from the supply grid is no longer possible. Enlarging the capacity of the link capacitor would in turn result in high costs. Moreover, the method cannot be used for influencing a three-phase supply current from the supply grid.

In the method known from EP 3 610 570 B1 also a vector control or field-oriented control of an electric motor is proposed, in order to achieve a constant motor power in spite of pulsating direct voltage. For influencing the supply current of a supply grid an additional power factor correction is required.

CN 1 15 378 332 A relates to a control of a permanently excited synchronous motor. The motor is operated using a converter circuit having a rectifier and a controllable inverter. In order to reduce harmonics and to increase the power factor a control of the two rotor currents is carried out, that are defined in the direction of the coordinate axes (d, q) in a rotor coordinate system that is immovable relative to the rotor.

### BRIEF SUMMARY

It can be considered as object of the present disclosure to provide a device and a method for operating an electric motor in order to influence the supply current provided by an alternating voltage grid in simple manner and to particularly reduce harmonics of the supply current.

This object is solved by means of a device for operating an electric motor including: a converter circuit that comprises a rectifier circuit and a controllable inverter circuit and that can be connected at an input side to an alternating voltage source and that is connected at an output side with the electric motor, wherein during operation a supply current flows from the alternating voltage source into the rectifier circuit, a control circuit that is configured to: to determine and to use only a first rotor current of at least one defined rotor current, so that a preset current progress for at least one phase of the supply current results and to thereby keep mechanical power provided by the electric motor uninfluenced, wherein the at least one rotor current is defined in a rotor coordinate system that is immovable relative to a rotor of the electric motor, determine at least one control signal for the inverter circuit based on the at least one rotor current and control the inverter circuit by means of the at least one control signal as well as a method for operating an electric motor including: rectifying a supply voltage provided by an alternating voltage source using a rectifier circuit, wherein a supply current from the alternating voltage source flows in the rectifier circuit, determining and using only a first rotor current from at least one defined rotor current, so that a preset current progress for at least one phase of the supply current results and thereby leaves mechanical power provided by the electric motor uninfluenced, wherein the at least one rotor current is defined in a rotor coordinate system that is immovable relative to a rotor of the electric motor, determining at least one control signal based on the at least one rotor current, inverting a rectified voltage provided by the rectifier circuit based on the at least one control signal by means of an inverter circuit for producing a current progress for the at least one phase of the supply current.

The device according to the present disclosure is configured for operating an electric motor. The device can be part of a system together with the electric motor to be operated. For example, the system can be configured to produce a fluid flow, particularly a gas flow, for example an air flow. The electric motor can be part of a fan, for example. Preferably the electric motor is an electronically commutated direct current motor (EC motor), that can also be denoted as brushless direct current motor.

The device has a converter circuit comprising a rectifier circuit and a controllable inverter circuit. In a preferred embodiment the rectifier circuit cannot be controlled and does not comprise controllable components, particularly components that can be switched between different switching conditions by means of a control signal. The rectifier circuit can comprise multiple diodes for rectifying the supply voltage of the alternating voltage grid, for example two diodes per phase of the alternating voltage grid. Preferably it is a three-phase alternating voltage grid, so that a three-phase supply voltage and a three-phase supply current are provided.

The inverter circuit can be controlled by means of a control circuit. The rectified voltage (that can also be denoted as link voltage) from the rectifier circuit is provided to the inverter circuit. The inverter circuit creates at least one motor phase current for an electric motor connected to the output side of the inverter circuit. The motor phase currents serve particularly for creation of a rotating field in the electric motor, in order to rotatingly drive a rotor of the electric motor. For producing the rotating field the electric motor can have multiple phases, for example three phases, to which one motor phase current is supplied in each case. Each phase can have multiple windings distributed in circumferential direction around the rotation axis of the rotor. The windings of different phases are arranged adjacent to one another in circumferential direction.

The control circuit is configured to operate as follows:

For the rotor a rotor coordinate system is defined, which is immovable relative to the rotor and which rotates together with the rotor. The rotor coordinate system particularly comprises two coordinate axes that can be denoted as d-axis and q-axis. The q-axis is thereby orientated substantially in magnetization direction of the rotor, while the d-axis is orientated orthogonal to the q-axis and thus substantially orthogonal to the magnetization direction of the rotor. Preferably two rotor currents are defined, namely a first rotor current (d-current) in direction of the d-axis and a second rotor current (q-current) in direction of the q-axis. By means of the first rotor current the flux density of the magnetic field of the rotor can be influenced. By means of the second rotor current the mechanical power and particularly the torque of the electric motor can be influenced. The mechanical power is proportional to the torque.

According to the present disclosure the first rotor current in direction of the d-axis is determined by means of the control circuit, so that a preset current progress for at least one phase, multiple phases or preferably all phases of the supply current results. Thus, a desired current form or a desired current progress can be predefined for the supply current (particularly for one, multiple or all phases of the supply current). By means of the converter circuit and particularly the inverter circuit a motor phase current is set for each phase of the electric motor in order to produce the rotating field. From the at least one phase of the supply current at least one motor phase current (for example three motor phase currents) can be created by means of the inverter circuit. The at least one motor phase current can be set using the control of the inverter circuit—preferably exclusively based on the control of the inverter circuit—whereby also the at least one phase of the supply current is influenced. By means of the at least one motor phase current, therefore, the at least one phase of the supply current can be influenced with the objective to achieve the respectively preset current progress. For adjusting the at least one phase of the supply current the first rotor current (d-current) is determined according to the present disclosure, so that the at least one motor phase current and thus the preset current progress of the supply current results therefrom.

The current progress of the supply current can be controlled in open-loop or closed-loop manner. The current progress for the at least one phase of the supply current is particularly characterized by a waveform, for example a sinusoidal waveform. Waveforms deviating therefrom, such as waveforms with triangular-shaped or trapezoid-shaped or step-shaped half-waves can also be preset. Additionally or alternatively, at least one additional current progress parameter can be preset for at least one phase of the supply current, for example a phase shift between the supply current and the supply voltage (which can be particularly preset equal to zero) and/or a maximum gradient (temporal change) of the supply current. The period of the supply current corresponds particularly to the period of the supply voltage.

The influence of the first rotor current in direction of the rotor-fixed d-axis (d-current) does not influence the mechanical power of the electric motor, so that a current shaping of the supply current is made possible without thereby influencing the mechanical power provided by the electric motor.

Based on the first rotor current determined in this manner the determination of at least one control signal for controlling the inverter circuit can then be carried out. The control of the inverter circuit can be carried out based on a space vector pulse width modulation, for example.

Thus, based on the vector closed-loop control (also denoted as field-oriented closed-loop control) of the electric motor by means of the first rotor current in the rotor coordinate system that is immovable relative to the rotor, an influencing of the supply current provided by the alternating voltage grid can be carried out in order to achieve a desired current form or a desired current progress. In doing so particularly the harmonics thereof can be reduced. Additionally or alternatively, the reactive power consumed from the alternating voltage grid can be controlled in closed-loop manner or can be reduced. In order to influence the current progress of the supply current, energy can be supplied to or taken from the rotor magnetic field. Because this influence is carried out by adjusting the first rotor current (d-current), which does not influence the mechanical power provided by the electric motor, the current forming of the grid current can be carried out very efficiently without affecting the operation of the electric motor in an undesired manner. An active circuit for power factor correction is not necessary. Particularly, actively controlled circuits (such as boost converters and/or buck converters and/or direct voltage converters) and/or actively controlled rectifier circuits on the grid or input side can be omitted.

Due to influencing of the first rotor current according to the present disclosure, particularly no specific influence of the rectified voltage (link voltage) provided by the rectifier circuit is carried out. Preferably no requirements for the rectified voltage in the direct voltage link are considered for determining the first rotor current used to influence the current progress of the grid voltage. For example, the determination of the first rotor current is carried out without presetting an absolute value for the voltage pulsation of the rectified voltage. Due to the present disclosure it is not the link voltage, but the current form or the current progress of the supply current that shall be influenced.

It is advantageous if one desired current progress is preset for each phase of the supply current respectively, wherein the current progresses for the multiple phases (for example three phases) can be identical apart from the phase shift between the phases. The current progress defines for each phase its temporal change and/or waveform and/or phase position relative to a voltage of the same phase. For example, the supply current can have positive and negative substantially sinusoidal half-waves with a defined duration.

For example, for each phase of the supply current for each period multiple positive current half-waves and multiple negative current half-waves can be preset and adjusted symmetrically to a zero crossing of the assigned phase voltage respectively.

It is preferred if the control circuit determines the first rotor current, so that the rotational speed of the rotor as well as the torque of the electric motor remain unchanged.

As explained for influencing of the at least one motor phase current and thus the supply current only one single rotor current is determined and used for determination of the at least one control signal, particularly the rotor current parallel to the d-axis of the rotor coordinate system (d-current). This rotor current is here denoted as first rotor current. A second rotor current (q-current), which is different from the first rotor current and which is orientated parallel to the q-axis of the rotor coordinate system, can be used independent from the first rotor current in order to set a mechanical power and particularly set a predefined torque. As already explained, setting the mechanical power and particularly the torque is independent from the current forming of the at least one motor phase current and/or the at least one phase of the supply current, as it is carried out according to the present disclosure. Thus, the supply current can be influenced also if the mechanical power shall remain constant.

Preferably the converter circuit does not have an additional controllable circuit for carrying out power factor correction. Particularly the rectifier circuit cannot be controlled, but consists of passive, non-controllable components, such as diodes. A grid-side clocked or switchable rectifier circuit is omitted. Switches in the rectifier circuit controlled with high frequency can therefore be omitted.

It is preferred if in the direct voltage link between the rectifier circuit and the inverter circuit a link capacitor and/or another suitable energy storage is provided. The rectified voltage provided by the rectifier circuit is applied to the link capacitor. This rectified voltage is particularly pulsating and can have comparably high voltage changes due to the pulsation. The capacity of the link capacitor is preferably comparably small. Particularly the capacitor can be charged during operation of the converter circuit during each period of the first rotor current from a minimum value to a maximum value and can be discharged again from the maximum value to the minimum value.

A method according to the present disclosure can be carried out by using any embodiment of the device described above or a modified embodiment of the device. The method comprises the rectification of a supply voltage provided by an alternating voltage grid. From the alternating voltage grid also a preferably multi-phase supply current is provided, the current progress of which shall be influenced. The supply current is converted into at least one motor phase current for operating the electric motor, particularly for producing of a rotating field. The at least one motor phase current in turn influences the current progress of the supply current, so that the supply current can be influenced indirectly by means of the motor phase current.

In a rotor coordinate system, which is immovable relative to the rotor of the electric motor, a rotor current is determined that is denoted as first rotor current here. The first rotor current is determined, so that a preset current progress for the at least one phase of the supply current and/or the at least one motor phase current is achieved. This current forming does not influence the mechanical power of the electric motor. The mechanical power of the electric motor and thus its working or operating point can be preset and adjusted independent from influencing the current form of the at least one motor phase current or supply current. Based on the determined first rotor current the at least one control signal is determined, which is subsequently used for producing the at least one motor phase current from the rectified voltage.

### BRIEF DESCRIPTION OF THE DRAWINGS

Advantageous embodiments of the present disclosure are derived from the dependent claims, the description and the drawing. In the following, preferred embodiments of the present disclosure are explained in detail based on the attached drawing. The drawing shows:

FIG. 1 a schematic basic illustration of an embodiment of a system comprising a device for operating an electric motor as well as an electric motor,

FIG. 2 an embodiment of a device for operating an electric motor as well as the electric motor in a block diagram,

FIG. 3 a block diagram of an embodiment of an open-loop or closed-loop control for use in the device according to FIGS. 1 and 2,

FIG. 4 a schematic basic illustration of voltages and currents resulting from the present disclosure, and

FIG. 5 a basic illustration of voltages and currents without the use of the present disclosure.

### DETAILED DESCRIPTION

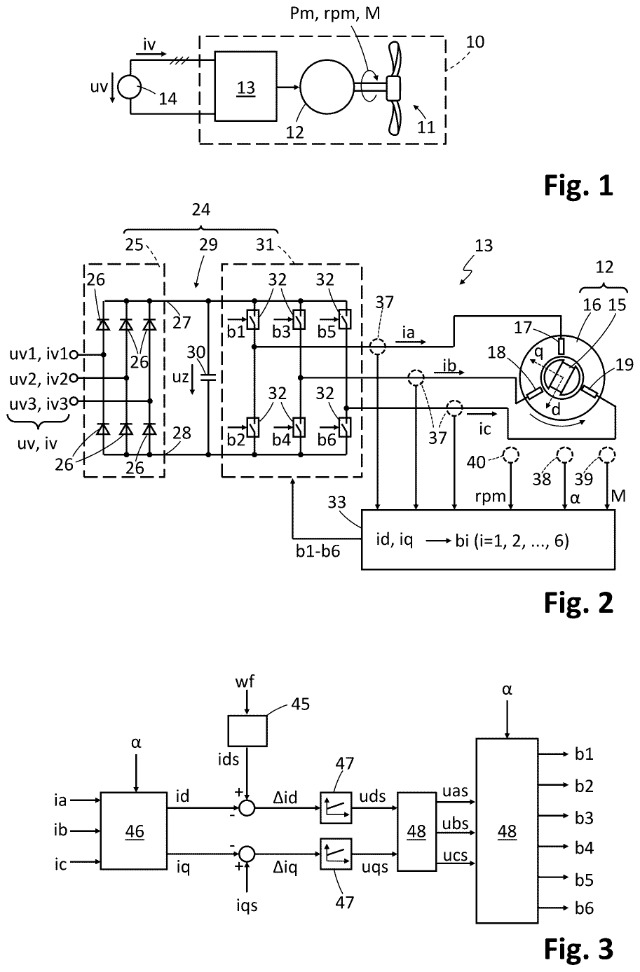

An embodiment of a system 10 is schematically illustrated in FIG. 1 that is configured for producing a fluid flow and according to the example a gas flow, particularly an air flow. The system 10 comprises a flow producing device, realized as fan 11 in the embodiment, comprising an electric motor 12. The electric motor 12 can rotatingly drive a fan impeller, fan vanes or the like in order to create the gas flow or air flow. The flow producing device could alternatively also be a pump for producing a fluid flow.

In addition, system 10 comprises a device 13 configured to operate the electric motor 12. The device 13 controls the electric motor 12 and supplies the latter with the electric power required for the operation. For this purpose, device 13 can be connected to an alternating voltage source 14 of an electrical supply grid. The alternating voltage source 14 provides a supply voltage uv as well as a supply current iv if the device 13 demands drawing of electrical power from the supply grid. As only schematically illustrated in FIG. 1 in the embodiment the supply grid configuration comprises multiple phases, for example three phases.

The electric motor 12 provides mechanical power Pm during operation, for example in order to drive the fan impeller or fan vanes in the system 10 illustrated in FIG. 1. The mechanical power Pm corresponds thereby to the product of the torque M of the electric motor and the rotational speed rpm of a rotor 15 of the electric motor 12. In other systems 10 the mechanical power Pm provided by the electric motor 12 can also be used to drive other apparatuses.

An embodiment of the device 13 and the electric motor 12 having a rotor 15 and a stator 16 are shown in the block diagram according to FIG. 2. In the embodiment the electric motor 12 is configured as electrically commutated direct current motor (EC motor). Such a motor is also denoted as brushless direct current motor (BLDC). For producing a rotating field, the electric motor 12 or the stator 16 comprises multiple motor phases that are arranged in a distributed manner in rotation direction of the rotor 15 around a rotation axis. In the embodiment illustrated in FIG. 2 three motor phases are provided: a first motor phase 17, a second motor phase 18 and a third motor phase 19. Each motor phase 17, 18, 19 can have one or multiple windings at different positions in rotation direction around the rotation axis depending on the configuration of the stator 16. The rotor magnetic field of rotor 15 is produced by permanent magnets according to the example.

A rotor coordinate system d, q comprising a d-axis and a q-axis that are orientated orthogonal to each other is defined immovably relative to the rotor 15. The rotor coordinate system rotates together with the rotor around the rotation axis. The q-axis is orientated in the direction of the magnetic poles of rotor 15, whereas the d-axis is orientated orthogonal thereto. The magnetic north pole and the magnetic south pole of the rotor 15 are thus arranged adjacent to one another in direction of the q-axis.

The device 13 is configured for control of the operation of the electric motor 12. For this purpose the device 13 controls a first motor phase current ia for the first motor phase 17, a second motor phase current ib for the second motor phase 18 as well as a third motor phase current ic for the third motor phase 19 in open-loop or closed-loop manner. The motor phase currents ia, ib, ic are adjusted by means of a converter circuit 24.

The converter circuit 24 comprises a rectifier circuit 25 that can be connected on the input side to the supply grid and thus the alternating voltage source 14 of the supply grid. The rectifier circuit 25 comprises three rectifier branches having two rectifier diodes 26 respectively. In each branch the rectifier diodes 26 are poled in a common forward direction. The rectifier diodes 26 of each rectifier branch form a series connection in a per se known manner, the center tap of which is connected with one phase of the supply grid in each case. The cathode side terminals of each rectifier branch are electrically connected with a first direct voltage connection 27 and all anode side terminals of each rectifier branch are electrically connected with a second direct voltage connection 28. Between the first direct voltage connection 27 and the second direct voltage connection 28 the rectifier circuit 25 provides a rectified voltage at the output side.

Here, the rectified voltage can be denoted as link voltage uz. The link voltage uz is provided at a direct voltage link 29 of converter circuit 24. In the embodiment the direct voltage link 29 comprises a link capacitor 30 to which the link voltage uz is applied. The capacitance Cz of the link capacitor 30 can be kept comparably small, because a current forming of the supply current iv can be carried out according to the present disclosure, even if the link voltage uz has a voltage pulsation with comparably high absolute value. For example, the absolute value of the voltage change can be minimum 30% or minimum 50% of the maximum value of the link voltage uz. In the embodiment the link voltage uz is not controlled in open-loop or closed-loop manner according to a requirement, but results from the control and adjustment of the motor phase currents ia, ib, ic.

In an optional embodiment a component for passive power factor correction (particularly without controlled switches)—such as an inductor—is present in the electrical connection between the first direct voltage connection 27 or the second direct voltage connection 28 on one side and the optionally provided link capacitor 30 or the inverter circuit 31 on the other side.

In the embodiment the rectifier circuit 25 does not comprise controllable switches. The conducting and blocking of the rectifier diodes 26 results from the sinusoidally shaped supply voltage and the link voltage uz applying in the direct voltage link 29.

A controllable inverter circuit 31 is connected to the direct voltage link 29. Based on the electrical energy or the electrical power provided in the direct voltage link 29 the motor phase currents ia, ib, ic are controlled in open-loop or closed-loop manner by means of control of the inverter circuit 31 for obtaining a preset current form or a preset current progress for one, multiple and preferably all motor phase currents ia, ib, ic, whereby the respectively corresponding phase of the supply current obtains a current progress that can correspond to a preset current progress wf.

The inverter circuit 31 comprises one separate inverter branch for each motor phase 17, 18, 19 respectively, that are connected parallel to one another and at which the link voltage uz is provided. Each inverter branch is thus electrically connected to the first direct voltage connection 27 on one side and to the second direct voltage connection 28 on the other side. In each inverter branch two controllable switches 32 are connected in series to one another. The center tap between the two controllable switches 32 is connected with the assigned motor phase 17 or 18 or 19.

Each controllable switch 32 is controlled by an assigned control signal bi (i=1 bis 6), that is created by a control circuit 33. The controllable switches 32 are preferably semiconductor switches, for example bipolar transistors, field effect transistors, IGBTs or the like. Each controllable switch 32 can be switched between a conducting condition and a blocking condition by means of the respectively assigned control signal. Thereby in each inverter branch or in each series connection of two controllable switches 32 at most one of the two controllable switches 32 is electrically conductive. In each inverter branch thus three switching conditions can be present, namely:
the controllable switch 32 connected with the first direct voltage connection 27 is electrically conductive, whereas the controllable switch 32 connected with the second direct voltage connection 28 blocks;
the controllable switch 32 connected with the first direct voltage connection 27 blocks, whereas the controllable switch 32 connected with the second direct voltage connection 28 is electrically conductive;
both controllable switches 32 are blocking.

The control signals bi (i=1, 2, . . . , 6) for the inverter circuit 31 are determined by the control circuit 33 based on a vector closed-loop control or field-oriented closed-loop control of the electric motor 12. In the context of the vector closed-loop control two rotor currents are available that can be adjusted independent from one another: a first rotor current id in direction of the d-axis and a second rotor current iq in direction of the q-axis of the rotor coordinate system d, q. The first rotor current id indicates the magnetic flux density of the rotor magnetic field, while the second rotor current iq serves for influencing and setting the mechanical power Pm and particularly the torque M of the electric motor 12. By means of the first rotor current id, therefore, a parameter is available, the adjustment of which does not influence the mechanical power Pm and by means of which the desired current progress of the motor phase currents ia, ib, ic and thus indirectly also the corresponding phases of the supply current iv can be achieved.

In the embodiment the motor phase currents ia, ib, ic are detected by means of one current sensor respectively and a current sensor signal that indicates the respective motor phase current ia, ib, ic is transmitted to the control circuit 33. Moreover, additional sensors can be present in order to detect one or more operating parameters of the electric motor 15. For example, a rotational position sensor 38 can be present in order to determine the rotational position α of the rotor 15 around the rotation axis (for example encoder, resolver, optical or inductive incremental or absolute value sensor). In addition, as an option, a torque sensor 39 can be provided for detection of the torque M, for example in order to control in closed-loop or open-loop manner the torque M by means of the second rotor current iq and/or depending on the load a resulting rotational speed rpm.

For example, based on the change of the rotational position α also the current rotational speed rpm of the electric motor can be determined. Additionally or alternatively, a rotational speed sensor 40 for determination of the rotational speed rpm can be provided.

In FIG. 3 a block diagram of a control is schematically illustrated that can be realized by means of the control circuit 33 or that can be implemented in the control circuit 33.

For the at least one phase iv1, iv2, iv3 of the supply current iv a desired current form or a desired current progress wf is preset. Depending therefrom, in a setpoint determination unit 45, a setpoint value ids for the first rotor current id can be determined. In the setpoint determination unit 45 models and/or algorithms and/or characteristic diagrams or the like can be determined that describe a relation between the preset current progress wf and the setpoint value ids of the first rotor current id.

Electrical power or energy can be drawn from the direct current link 29 and can be transferred in the magnetic field of the respective motor phase 17, 18, 19 or vice versa power or energy can be drawn from the magnetic field and transferred into the direct voltage link 29 for influencing the flux density of the rotor magnetic field. If the first rotor current id as well as its temporal change are both positive or are both negative respectively, electrical energy is transferred into the magnetic field of the respective motor phase 17, 18, 19 from the direct voltage link 29. If the first rotor current id and its temporal change have different signs (rotor current id is larger than zero and the temporal change is less than zero or vice versa) electrical energy is transferred from the magnetic field of the respective motor phase 17, 18, 19 into the direct voltage link 29. This transfer of energy can therefore be carried out using the first rotor current id based on the vector closed-loop control, so that the mechanical power Pm of the electric motor 12 can be maintained without being affected.

Assuming that the reluctance power is equal to zero, it applies for the electrical power Pel of the electric motor 12:

$$Pel = \frac{3}{2} \cdot ( Rs ( id {( t )}^{2} + iq {( t )}^{2} ) + Ls ( id ( t ) \frac{id ( t )}{dt} + iq \frac{iq ( t )}{dt} ) + iq \cdot uq ) \qquad ( 1 )$$

Thereby Rs is the resistance of a motor phase 17, 18, 19, Ls is the inductance of a motor phase 17, 18, 19 transformed into the rotor coordinate system d, q, id is the first rotor current, iq is the second rotor current and uq is the pole wheel voltage in the rotor coordinate system. The pole wheel voltage uq in the rotor coordinate system is known and can be determined by means of a table, a function, a characteristic line, a characteristic diagram or the like depending on the operating condition or the operating point of the electric motor 12.

For the power Pz in the direct voltage link applies:

$$Pz = Cz \frac{uz ( t )}{dt} uz ( t ) \qquad ( 2 )$$

wherein Cz is the capacity of the link capacitor 30 and uz is the link voltage.

The supply power Pv that has to be provided by the supply grid or the alternating voltage source 14 results from the sum of the electrical power of the electric motor 12 and the electrical power in the direct voltage link:

$$Pv = Pel + Pz = uv ( t ) \cdot iv ( t ) \qquad ( 3 )$$

The power Pv that has to be provided by the supply grid also corresponds to the product of the supply current iv and the supply voltage uv.

As long as the electric motor 12 operates in a current operating point, the second rotor current iq is constant and its temporal change is thus equal to zero. If now for the supply current iv a current form is desired, such as a sinusoidal current without phase shift relative to the grid voltage uv, the determination of the first rotor current id can be carried out based on the equations (1) to (3).

Therefore, a set point value ids for the first rotor current id can be determined based on the above-indicated equations by means of a current progress for the supply current iv that is to be achieved.

A set point value iqs for the second rotor current iq is determined dependent from the desired mechanical power Pm or the desired torque M of the electric motor 12.

Based on the current motor phase currents ia, ib, ic under consideration of the current rotational position α of rotor 15 the current values for the first rotor current id and the second rotor current iq can be determined in a transformation unit 46. For example, the transformation unit 46 can transform the motor phase currents ia, ib, ic using a Clarke-transformation and a Park-transformation into the rotor currents id, iq of the rotor coordinate system d, q. A difference Δid of the first rotor current between the set point value ids and the current value of the first rotor current id can be determined and can be submitted to a controller 47, according to the example a PI-controller. Analog to this the difference Δiq of the second rotor current between the set point value iqs and the current value for the second rotor current iq can be determined and can also be submitted to a controller 47, according to the example a PI-controller. The controller outputs of the two controllers 47 provide rotor set point voltages uds, uqs in the rotor coordinate system d, q. These voltages are subsequently converted by means of a back transformation unit 48 using a back transformation (Clarke-Park) into the motor phase set point voltages uas, ubs, ucs for the motor phases from which in turn the motor phase currents ia, ib, ic result.

The motor phase set point voltages uas, ubs, ucs are submitted to a control signal determination unit 49. Additional parameters, such as the rotational position α, can be submitted optionally to the control signal determination unit 49. The control signal determination unit 49 is configured to determine the control signals b1 to b6 for control of the inverter circuit 39. For this purpose, the motor phase set point voltages uas, ubs, ucs are used for computing the control signals b1 to b6 based on a space vector pulse width modulation.

By controlling the inverter 31 based on the control signals b1 to b6 determined in this manner then, in turn, the respective current values for the motor phase currents ia, ib, ic result, which in turn influence the respective associated phase of the supply current iv, so that they correspond to the preset current form or the preset current progress wf.

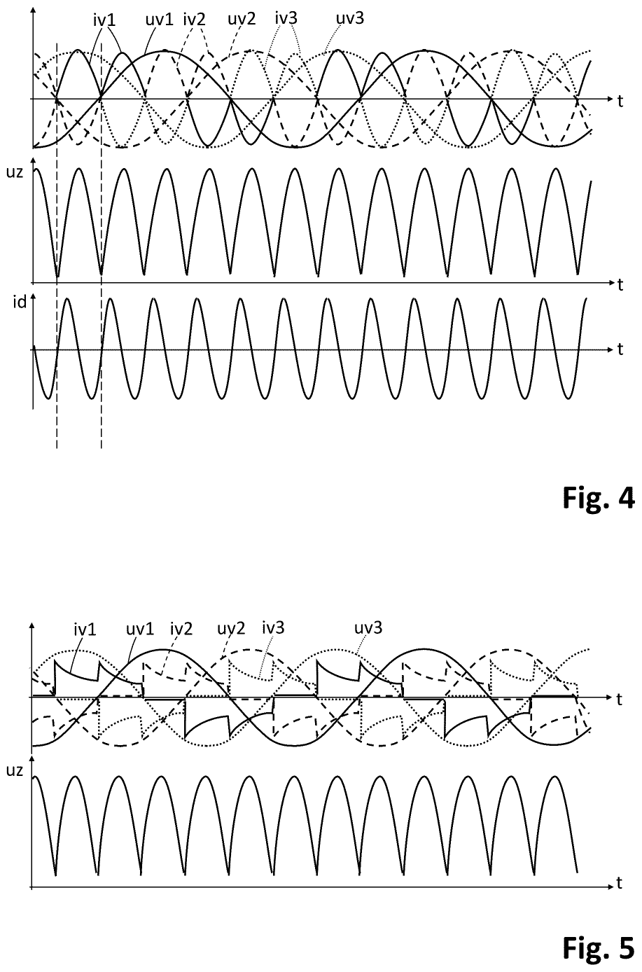

In FIG. 4 the current progress for the motor phase currents ia, ib, ic resulting from the present disclosure and their phase position relative to the respectively associated phase voltage ua, ub, uc is illustrated. FIG. 4 also shows the link voltage uz as well as the first rotor current id that has been determined as explained above, so that the voltage progresses uv1, uv2, uv3 of the phases of the supply voltage uv and the current progresses iv1, iv2, iv3 of the phases of the supply current iv result.

Compared to this, FIG. 5 shows voltage progresses uv1, uv2, uv3 of the phases of the supply voltage uv and the current progresses iv1, iv2, iv3 of the phases of the supply current iv as well as the link voltage uz without implementing the present disclosure and without influence by means of the first rotor current id. It is apparent that the current progresses iv1, iv2, iv3 of the phases of the supply current iv comprise steep flanks and step-like progresses, whereby considerable harmonics of the supply current iv result, which is avoided by the present disclosure as shown in FIG. 4.

As apparent from FIG. 4, the current progresses iv1, iv2, iv3 of the phases of the supply current iv according to the present disclosure comprise sinusoidal half-waves (positive and negative half-waves) according to the example. For example, each current progress iv1, iv2, iv3 of the phases of the supply current iv has one positive half-wave directly before and one positive half-wave directly after a zero crossing of the voltage progress uv1, uv2, uv3 of the assigned phase of the supply voltage uv with a positive phase voltage gradient and has one negative half-wave directly before and one negative half-wave directly behind a zero crossing of the voltage progress uv1, uv2, uv3 of the assigned phase of the supply voltage uv with negative phase voltage gradient. Between the two positive half-waves and the two negative half-waves the respective current progress iv1, iv2, iv3 of the phases of the supply current iv is equal to zero.

The duration of the half-waves is preferably at least substantially equal. The duration during which a current progress iv1, iv2, iv3 of the phases of the supply current iv is equal to zero between the two positive and the two negative half-waves corresponds preferably to the duration of a positive or negative half-wave. A period of the voltage progress uv1, uv2, uv3 of the phase of the supply voltage uv corresponds to the duration of six half-waves of the current progress iv1, iv2, iv3 of the assigned phase of the supply current iv according to the example.

It is also apparent in FIG. 4 that the first rotor current id has a sinusoidal progress in the embodiment and that the period of the first rotor current id corresponds to the duration of a half-wave of a current progress iv1, iv2, iv3 of the phases of the supply current and thus one sixth of the period of the voltage progress uv1, uv2, uv3 of the phases of the supply voltage uv. The link voltage uz illustrated in FIG. 4 results from the adjustment of the first rotor current id and the motor phase currents ia, ib, ic. The link voltage uz is not controlled in open-loop or closed-loop manner according to a requirement.

The present disclosure refers to device 13 as well as a method for operating an electric motor 12. For example, the electric motor 12 can be part of a flow producing device, such as a fan 11. The device 13 comprises a converter circuit 24 having a preferably passive rectifier circuit 25 and a controllable inverter circuit 31, that are coupled with each other, particularly via a direct current link 29. The direct current link 29 can comprise a link capacitor 30 or another link energy storage as an option. Preferably exclusively the inverter circuit 31 can be controlled. A desired current form or a desired current progress (preset current progress wf) is preset for at least one motor phase current ia, ib, ic and/or at least one phase of a supply current iv of the supply grid. Based on a vector closed-loop control (field-oriented closed-loop control) of the electric motor a first rotor current id in a coordinate system d, q fixed to the rotor can be determined, wherein the first rotor current id does not influence the mechanical power Pm of the electric motor 12. Based on the rotor current id then one or more control signals b1 to b6 for control of the inverter circuit 31 can be determined in a control circuit 33 and the inverter circuit 31 can be controlled respectively, whereby the desired current progress wf for the motor phase currents ia, ib, ic and/or the at least one phase of a supply current iv results. At least a controllable or active circuit for power factor correction can be omitted, whereby a purely passive non-controllable circuit for power factor correction (for example at least one inductor) can be provided as an option. The supply current iv from the supply grid is influenced by storing energy in or drawing energy from the magnetic field of the electric motor 12, without the need to thereby change the mechanical power Pm provided by the electric motor 12.

### LIST OF REFERENCE SIGNS

10 System
11 fan
12 electric motor
13 device
14 alternating voltage source
15 rotor
16 stator
17 first motor phase
18 second motor phase
19 third motor phase
24 converter circuit
25 rectifier circuit
26 rectifier diode
27 first direct voltage connection
28 second direct voltage connection
29 direct voltage link
30 link capacitor
31 inverter circuit
32 controllable switch
33 control circuit
37 current sensor
38 rotational position sensor
39 torque sensor
40 rotational speed sensor
45 set point determination unit
46 transformation unit
47 controller
48 back transformation unit
49 control signal determination unit
α rotational position of rotor
bi control signal (i=1 bis 6)
d d-axis of rotor coordinate system
ia first motor phase current
ib second motor phase current
ic third motor phase current
id first rotor current
ids set point for first rotor current
iq second rotor current
iqs set point for second rotor current
iv supply current
iv1 first phase of supply current
iv2 second phase of supply current
iv3 third phase of supply current
M torque
Pm mechanical power
q q-axis of rotor coordinate system
rpm rotational speed
ua first motor phase voltage
uas set point voltage for first motor phase voltage
ub second motor phase voltage
ubs set point voltage for second motor phase voltage
uc third motor phase voltage
ucs set point voltage for third motor phase
uds first rotor set point voltage
uqs second rotor set point voltage
uv supply voltage
uv1 first phase of supply voltage
uv2 second phase of supply voltage
uv3 third phase of supply voltage
uz link voltage
wf preset current progress

1. A device for operating an electric motor comprising:
a converter circuit that comprises a rectifier circuit and a controllable inverter circuit and that can be connected at an input side to an alternating voltage source and that is connected at an output side with the electric motor, wherein during operation a supply current flows from the alternating voltage source into the rectifier circuit,
a control circuit that is configured to:
to determine and to use only a first rotor current of at least one defined rotor current, so that a preset current progress for at least one phase of the supply current results and to thereby keep mechanical power provided by the electric motor uninfluenced, wherein the at least one rotor current is defined in a rotor coordinate system that is immovable relative to a rotor of the electric motor,
determine at least one control signal for the inverter circuit based on the at least one rotor current and
control the inverter circuit by means of the at least one control signal.

2. The device according to claim 1, wherein one current progress is preset for each phase of the supply current to the control circuit.

3. The device according to claim 1, wherein the control circuit is configured to determine the first rotor current, so that a rotational speed of the rotor of the electric motor as well as a torque provided by the electric motor remain uninfluenced.

4. The device according to claim 1, wherein the at least one rotor current defines an absolute value for a current vector respectively by means of which a vector closed-loop control of the electric motor can be carried out.

5. The device according to claim 1, wherein the control circuit is configured to use a second rotor current, which is different from the first rotor current, for setting the mechanical power.

6. The device according to claim 1, wherein for influencing at least one motor phase current provided by the converter circuit only the first rotor current is used that influences a magnetic flux density in a magnetic field of the rotor.

7. The device according to claim 1, wherein the control circuit is configured to carry out a space vector pulse width modulation of the inverter circuit based on the at least one rotor current.

8. The device according to claim 1, wherein the converter circuit is realized without additional controllable circuit for carrying out a power factor correction.

9. The device according to claim 1, wherein the rectifier circuit does not comprise controllable switches.

10. The device according to claim 1, wherein the converter circuit comprises a direct voltage link between the rectifier circuit and the inverter circuit, wherein a pulsating rectified link voltage is applied in the direct voltage link.

11. The device according to claim 10, wherein the direct voltage link comprises a link capacitor and/or another energy storage for electrical energy.

12. The device according to claim 1, wherein the electric motor is a brushless direct current motor.

13. A system comprising the device according to claim 1 as well as the electric motor.

14. A method for operating an electric motor comprising:
rectifying a supply voltage provided by an alternating voltage source using a rectifier circuit, wherein a supply current from the alternating voltage source flows in the rectifier circuit,
determining and using only a first rotor current from at least one defined rotor current, so that a preset current progress for at least one phase of the supply current results and thereby leaves mechanical power provided by the electric motor uninfluenced, wherein the at least one rotor current is defined in a rotor coordinate system that is immovable relative to a rotor of the electric motor,
determining at least one control signal based on the at least one rotor current,
inverting a rectified voltage provided by the rectifier circuit based on the at least one control signal by means of an inverter circuit for producing a current progress for the at least one phase of the supply current.

15. The device according to claim 2, wherein the control circuit is configured to determine the first rotor current, so that a rotational speed of the rotor of the electric motor as well as a torque provided by the electric motor remain uninfluenced.

16. The device according to claim 15, wherein the at least one rotor current defines an absolute value for a current vector respectively by means of which a vector closed-loop control of the electric motor can be carried out.

17. The device according to claim 16, wherein the control circuit is configured to use a second rotor current, which is different from the first rotor current, for setting the mechanical power.

18. The device according to claim 17, wherein for influencing at least one motor phase current provided by the converter circuit only the first rotor current is used that influences a magnetic flux density in a magnetic field of the rotor.

19. The device according to claim 18, wherein the control circuit is configured to carry out a space vector pulse width modulation of the inverter circuit based on the at least one rotor current.

20. The device according to claim 19, wherein the converter circuit is realized without additional controllable circuit for carrying out a power factor correction.
